(19) United States
(12) Patent Application Publication
(10) Pub. No.: US 2007/0259077 A1
(43) Pub. Date: Nov. 8, 2007

(54) Method for the Treatment and Long-Term Preservation of Meat Products Without a Cold Chain

(76) Inventors: Pablo Roman Curutchet Ferreira, Barcelona (ES); Marcelo Masana Rinero, Buenos Aires (AR); Sergio Vaudagna Barbero, Buenos Aires (AR); Guillermo Sanchez Danguise, Buenos Aires (AR)

Correspondence Address: HOLLAND & KNIGHT LLP, 2099 PENNSYLVANIA AVE, SUITE 100, WASHINGTON, DC, 20006, US

(21) Appl. No.: 10/581,866

(22) PCT Filed: Dec. 7, 2004
(86) PCT No.: PCT/ES04/00548

§ 371 Date: May 14, 2007

(30) Foreign Application Priority Data
Dec. 5, 2003 (AR) 030104507

(51) Int. Cl. A23B 4/023

(52) U.S. Cl. 426/97

(57) ABSTRACT

A process for conditioning and conservation of meat products for long periods of time, without the need of a cold chain, with the process comprising the following steps: a) Injecting each piece of meat with a brine solution containing NaCl in at least a concentration to reach a maximum of 20% of the weight of the injected piece of meat; b) Massaging the injected pieces of meat for 8 to 24 hours under a reduced pressure of between 10 and 15″ HG and a reduced temperature of between 0° C. and 3° C.; c) Introducing each piece of meat into a sealed bag made of an impervious polymer, and subjecting the batch of meat cuts to a cooking process in hot water until reaching a temperature of 70° C. to 85° C. measured in the core of the biggest piece of meat for a time of 15 to 30 minutes; d) Removing the bags with the meat from the cooking water, removing the meat from each bag and cooling the meat until reaching a temperature of about 26° C. measured in the geometrical center of the pieces of meat; e) Once the cooling step has finished, packaging each pre-cooked piece of meat in other bags apt for vacuum packaging; f) Once the meat pieces are packaged, freezing the pieces to a temperature of about −14° C.; g) Subjecting the already packaged pieces of meat to an irradiation process until cumulating a minimum total dose of 15 kGy.

The present invention relates to a process for conditioning and conservation of meat products for long periods of time and without the need of a cold chain system.

More particularly, the present invention encircles the steps of a process for permitting the conditioning and preservation of meat cuts for their transportation and storage for a determined period of time without the need of providing a cold chain for their conservation.

### DESCRIPTION OF THE PRIOR ART

Since long time ago it is well known that any meat piece or cut of meat is submerged into a saturated saline solution and then permitted to dry for “curing” the same for obtaining a solid product, with disagreeable appearance, but capable of being conserved for a long time without decomposition, even when their nutritional and organoleptic properties are poor and deficient.

Since about the 50's and 60's the development of frigorific installations permitted to freeze and transport the meat pieces in refrigerated wagons for then maintaining the meat in cooling chambers either to further maritime transportation or terrestrial transportation in big cities for final selling. This procedure is known as “cold chain” and it operates very well always and when the cold chain is not interrupted.

There are places, however, where these installations are not provided either because they are not cost effective or because of technological and equipment deficiencies, for example in some countries in the world.

These technology and equipment deficiencies prevent the supplying of large volumes of meat products because even if these meat pieces are transported in refrigerated ships the product can not be preserved in destination because of the lack of such installations.

The above commented problem is a bar for entering and capturing new and non traditional markets with the result of loosing business opportunities.

There are other more primitive methods for curing the meat but all of them, put in practice since ancient times, consist of drying the meat under the protection of nitrites and concentrated ClNa, or consist of smoking the meat, etc. but none of these known methods results in a soft meat ready for consumption or cooking, such as a piece of meat just processed, tender and soft and with most of their natural fluids.

While other processes, such as the one for obtaining corned beef, do not need of cold chain for conservation purposes they need of hermetic tin cans for a correct conditioning and conservation, which processes and components are very costly.

### OBJECTS OF THE INVENTION

It is an object of the present invention to provide a process for conditioning meat cuts and for conserving the same in apt conditions for consumption for up to 8 months without the need of a cold chain, with the meat being capable of being conserved under temperatures of up to 30° C. without spoilage.

It is another object of the present invention to provide the conditioning of meat cuts or pieces in containers or packages made of recycled and low cost materials, such as plastic bags, cardboard boxes, or a combination thereof, either for transportation as well as for storage and conservation, without the product being spoiled.

It is also an object of the present invention to provide a process for conserving, without deterioration, meat pieces apt for consumption for up to 8 months, without loosing the meat organoleptic characteristics, that is maintaining the meat cuts soft, tender and with most of the natural fluids in intact conditions, as well as with agreeable colour and taste.

Finally, it is an object of the present invention to take advantage of second-selection meat cuts and to obtain a product with excellent characteristics for consumption, which second-selection cuts are generally not considered for traditional processes of conservation under cold chain for exportation purposes.

### DESCRIPTION OF THE PRESENT INVENTION

It is a process for conditioning and conservation of meat products for long periods of time, without the need of a cold chain, including the steps of selecting and cutting meat into meat cuts or pieces, cutting up the meat pieces, if necessary, for removing fat and minor portions or waste cuttings thereof, to obtain pieces having a size and weight within a uniform range, the process being characterized by the following steps:

a) each piece of meat was injected with a brine solution containing NaCl in at least a concentration to reach a maximum of 20% of the weight of the injected piece of meat;

b) once all the pieces of meat within a batch have been injected the meat is massaged for a period of time of within 8 to 24 hours under reduced pressure and temperature;

c) removing the batch from the massage machine and introducing each piece of meat into a sealed bag made of an impervious polymer, and subjecting the bagged meat to a cooking process in hot water until reaching a temperature of 70° C. to 85° C. measured in the core of the biggest piece of meat for a time of 15 to 30 minutes;

d) removing the bags with the meat from the cooking water, removing the meat from each bag and cooling the meat until reaching a temperature of about 26° C. measured in the geometrical center of the pieces of meat;

e) once the cooling step has finished each pre-cooked piece of meat is packaged;

f) once the pieces of meat have been packaged the same are subject to a freezing process at a temperature of about −14° C.;

g) the pieces of meat thus packaged are subject to an irradiation process until cumulating a minimum total dose of 15 kGy.

It is to be remarked that in step e) the pieces of meat may be packaged into bags made of the material “BTECIN” of the firm Sealed Air Co. Argentina, or in any other packaging for the same purpose, and then the bags are packaged in cardboard boxes.

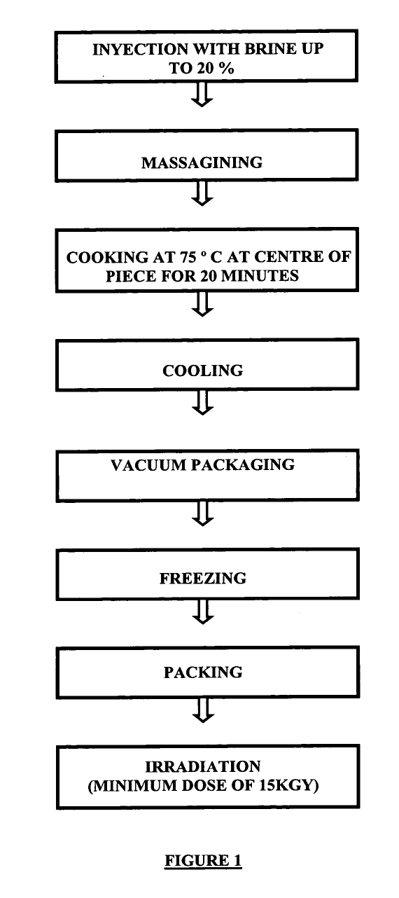

In order to illustrate a better practical form of carrying out the above disclosed steps FIG. 1 shows a blocks diagram indicating the main operations, also for supporting an example of each of such steps, with the proviso that such steps correspond to just an example carried out under conditions in a laboratory therefore it must be understood that such conditions may vary when the process is carried out in industrial scale.

Raw Material Employed in the Process:

For each test 40 Kg of meat were cut into pieces of 10 Kg. and each bag contained a cut of “paleta” namely cut up pieces selected from supra-spinal muscles, infra-spinal muscles, trapezium muscle, deltoids, wide dorsal muscle, triceps brachial, fascia tensor and ante-brachial. Minor portions and fat were eliminated. Each cut was weighted by separate for each bag and the minor portions and fat were removed.

Injection:

The formulation of the injection solution was defined by determining the concentrations of nitrite and sodium chloride necessary to reach, in the processed product, a concentration of 3.5% ClNa/100 g of cooked product and an amount not exceeding the 150 ppm of sodium nitrite in the cooked product, this corresponding to about 20%/w of the non processed piece or cut of meat.

An injecting machine having only one needle Dick Lokespritze Esslingen A. NX. was employed.

Massaging:

Massaging is necessary to obtain a correct uniform distribution of the injected brine solution in all the piece of meat under treatment.

A massaging drum or barrel “KOCH”, having a maximum capacity of 90 Kg. and a rotation rate of 0 to 9 r.p.m. was employed. The 40 Kg. of pieces of meat were introduced into the drum and a vacuum of 15″ HG was produced, with the drum operating at 5 r.p.m. under refrigeration at −1° C.

Two massaging tests were carried out, one of them for 8 hours and the other one for 24 hours.

Cooking:

The cooking step was determined for reaching a temperature of 75° C. in the center of the pieces of meat for a cooking time of 20 minutes. To that purpose an autoclave “MICROFLOW” was employed, with water showers to simulate a cooking into a water bath. Before this cooking each piece of meat was sealed into a bag made of high density polyethylene from the firm CT Plast. The treatment water was initially at a temperature of 80° C. and was kept at this temperature until the biggest piece of meat reached the mentioned temperature of 75° C. and counted from this moment the cooking was maintained for 20 minutes.

Cooling:

Once the cooking was finished each piece of meat was cooled down at a temperature of about 26° C.

Packaging Under Vacuum:

Once the cooling down was finished each piece of meat was packaged under vacuum into bags such as the bags “BTECIN” from the firm Sealed Air Co, from Argentina.

Packaging:

Cardboard boxes having 40 cm wide, 60 cm long and 16 cm high were employed and 6 pieces of meat were packaged into each one of these boxes. This step may be carried out as indicated or after the following freezing step.

Freezing:

Once cooled down and packaged the pieces of meat were frozen to −14° C., either packaged in the plastic bags or with the bags packaged into the cardboard boxes.

Irradiation:

The boxes were subject to gamma-ray irradiation in the Centro Atómico de Ezeiza, Argentina, to cumulate a minimum dose of 15 kGY.

The following results tables, made by the INTA and signed in February 2003 in the “Centro de Investigación de Agroindustria de Morón, Province of Buenos Aires, shows the benefits of the process of the present invention and how the objects are achieved.

Concentrations of Salts in Solution:

ClNa (%): 18.96%

NO2Na (g/kg): 0.9 g/kg.

Note: Continuous massaging for 8 hours

BAG PERFORMANCE

| | BAG: | BAG: | | | |
|---|---|---|---|---|---|
| | NOMINAL | TOTAL | | | |
| | WEIGHT | WEIGHT | PREOCESSED | WASTE | |
| BAG # | g | g | MEAT % | CUTS % | FAT % |
| 1 | 11300.00 | 11300.00 | 63.78 | 22.89 | 13.33 |
| 2 | 10500.00 | 10480.20 | 60.16 | 31.87 | 7.97 |
| 3 | 8850.00 | 8736.30 | 60.96 | 26.21 | 12.83 |
| 4 | 11600.00 | 11473.40 | 66.75 | 27.03 | 6.22 |
| 5 | 10450.00 | 10358.50 | 60.53 | 30.71 | 8.76 |
| 6 | 10700.00 | 10700.00 | 64.68 | 30.77 | 4.55 |

Weight Variation of Each Meat Piece During the Process

| I | II | III | IV | V | VI | VII | VIII |
|---|---|---|---|---|---|---|---|
| 1 | Paleta | 3427.30 | 19.82 | 17.49 | −1.41 | −30.38 | −14.30 |
| 2 | Chingolo | 1444.70 | 19.84 | 16.77 | −1.21 | −39.36 | −23.70 |
| 3 | Marucha | 2334.90 | 20.57 | 17.39 | −0.62 | −27.67 | −10.90 |
| 4 | Paleta | 2971.50 | 20.39 | 18.12 | −1.38 | −23.60 | −6.86 |
| 5 | Chingolo | 1281.40 | 21.09 | 17.19 | −2.30 | −36.87 | −21.98 |
| 6 | Marucha | 2052.30 | 20.42 | 17.02 | −2.04 | −25.16 | −10.18 |
| 14 | Chingolo | 1226.40 | 20.88 | 18.16 | −2.35 | −30.99 | −15.18 |

NOTES ABOUT THE ABOVE TABLE:
I: Sample Number;
II: Type of Meat Cut;
III: Initial Weight, in gr.;
IV: Level of Real Injection, in %;
V: Variation with the beginning of massage, in %;
VI: Variation in massage and burn, in %;
VII: Variation in Cooking, in %;
VIII: Total Variation, in %.

Yields related to the raw matter subject to the process

| | | | Individual | Global |
|---|---|---|---|---|
| Sample # | Bag # | Meat Cut | Yield % | Yield % |
| 1 | 1 | Paleta | 87.70 | 84.92 |
| 2 | | Chingolo | 76.30 | |
| 3 | | Marucha | 89.10 | |
| 4 | 2 | Paleta | 93.14 | 88.99 |
| 5 | | Chingolo | 78.02 | |
| 6 | | Marucha | 89.82 | |
| 14 | | Chingolo | 84.82 | |

Concentrations of Salts in Solution:

ClNa (%): 18.96%

NO2Na (g/kg): 0.9 g/kg.

Note: Continuous massaging for 24 hours

BAG PERFORMANCE

| | BAG: | BAG: | | | |
|---|---|---|---|---|---|
| | NOMINAL | TOTAL | | | |
| | WEIGHT | WEIGHT | PREOCESSED | WASTE | |
| BAG # | g | g | MEAT % | CUTS % | FAT % |
| 7 | 10600.00 | 10544.30 | 61.87 | 32.87 | 5.27 |
| 8 | 10450.00 | 10414.90 | 65.55 | 28.17 | 6.29 |
| 9 | 8100.00 | 8052.80 | 59.04 | 32.24 | 8.72 |
| 10 | 7400.00 | 7331.60 | 60.80 | 29.77 | 9.43 |
| 11 | 11200.00 | 11143.30 | 59.71 | 28.06 | 12.23 |
| 12 | 8550.00 | 8504.30 | 67.55 | 23.35 | 9.10 |

Weight Variation of Each Meat Piece During the Process

| I | II | III | IV | V | VI | VII | VIII |
|---|---|---|---|---|---|---|---|
| 19 | Paleta | 3127.30 | 20.84 | 18.28 | −1.48 | −29.96 | −13.16 |
| 20 | Chingolo | 1362.00 | 21.70 | 19.45 | −2.02 | −42.22 | −24.79 |
| 21 | Marucha | 2034.30 | 21.38 | 18.42 | −1.46 | −28.44 | −11.48 |
| 22 | Paleta | 3290.50 | 21.25 | 20.21 | −2.38 | −29.87 | −12.05 |
| 23 | Chingolo | 1337.00 | 21.89 | 21.19 | −3.85 | −43.49 | −26.16 |
| 24 | Marucha | 2199.10 | 21.15 | 19.22 | −1.60 | −29.78 | −12.15 |

NOTES ABOUT THE ABOVE TABLE:
I: Sample Number;
II: Type of Meat Cut;
III: Initial Weight, in gr.;
IV: Level of Real Injection, in %;
V: Variation with the beginning of massage, in %;
VI: Variation in massage and burn, in %;
VII: Variation in Cooking, in %;
VIII: Total Variation, in %.

Yields related to the raw matter subject to the process

| | | | Individual | Global |
|---|---|---|---|---|
| Sample # | Bag # | Meat Cut | Yield % | Yield % |
| 19 | 7 | Paleta | 88.84 | 64.93 |
| 20 | | Chingolo | 75.21 | |
| 21 | | Marucha | 88.52 | |
| 22 | 8 | Paleta | 87.95 | 85.16 |
| 23 | | Chingolo | 73.84 | |
| 24 | | Marucha | 87.85 | |

1. A process for conditioning and conservation of meat products for long periods of time, without the need of a cold chain, including the steps of selecting and cutting meat into meat cuts or pieces, cutting up the meat pieces, if necessary, for removing fat and minor portions thereof, to obtain pieces having a size and weight within a uniform range, the process being characterized by the following steps:
a) Injecting each piece of meat with a brine solution containing NaCl in at least a concentration to reach a maximum of 20% of the weight of the injected piece of meat;
b) Once all the pieces of meat within a batch have been injected the meat is massaged for a period of time of within 8 to 24 hours under a reduced pressure of between 10 and 15″ HG and a reduced temperature of between 0° C. and 3° C.;
c) Removing the batch from the massage machine and introducing each piece of meat into a sealed bag made of an impervious polymer, and subjecting the bagged meat to a cooking process in hot water until reaching a temperature of 70° C. to 85° C. measured in the core of the biggest piece of meat for a time of 15 to 30 minutes;
d) Removing the bags with the meat from the cooking water, removing the meat from each bag and cooling the meat until reaching a temperature of about 26° C. measured in the geometrical center of the pieces of meat;
e) Once the cooling step has finished, packaging each pre-cooked piece of meat in other bags apt for vacuum packaging;
f) Freezing the pieces of meat already conditioned to a temperature of about −14° C.;
g) Subjecting the already packaged and frozen pieces of meat to an irradiation process until cumulating a minimum total dose of 15 kGy.

2. A process for conditioning and conservation of meat products for long periods of time, without the need of a cold chain, according to claim 1, the process being characterized in that the brine solution comprises 1.2 g/kg of sodium nitrite solution and 19.5% of NaCl.

3. A process for conditioning and conservation of meat products for long periods of time, without the need of a cold chain, according to claim 1, the process being characterized in that the massage step is carried out under a reduced pressure of 15″ HG at 1° C. for 8 hours.
